(19) United States
(12) Patent Application Publication
(10) Pub. No.: US 2010/0119799 A1
(43) Pub. Date: May 13, 2010

(54) COMPOSITIONS FOR SYNTHETIC PAPERS AND ECOLOGIC FILMS FOR WRITING AND PRINTING, SYNTHETIC PAPERS AND FILMS OBTAINED FROM SUCH COMPOSITIONS, AND USES THEREOF

(75) Inventors: Sati Manrich, Sao-Carlos (BR); Oswaldo José Danella, JR., Sao Carlos (BR); Cristiano Ribeiro Santi, Sao Carlos (BR); Ana Carolina Corrêa, Sorocaba (BR); Aldo Arruda Mortara, Sao Paulo (BR)

Correspondence Address: DUANE MORRIS LLP - Philadelphia;IP DEPARTMENT, 30 SOUTH 17TH STREET, PHILADELPHIA, PA, 19103-4196, US

(73) Assignee: Fundacao Universidade Federal de Sao Carlo- UFSCar and Vitopel do Brasil Ltda

(21) Appl. No.: 12/595,855

(22) PCT Filed: Apr. 15, 2008
(86) PCT No.: PCT/BR08/00107

§ 371 Date: Jan. 21, 2010

(30) Foreign Application Priority Data
Apr. 16, 2007 (BR) PI0701443-0

(51) Int. Cl. C08K 3/26; B32B 27/32

(52) U.S. Cl. 428/220; 524/427

(57) ABSTRACT

Compositions for synthetic papers, flat and tubular films, and coextruded films for writing and printing are described, from recycled and virgin thermoplastic polymers, mineral loads and additives-based composites, and using multilayer or monolayer processes of biaxial or monoaxial orientation. Polyolefinic polymers such as polypropylene (PP), polyethylene and its copolymers, in addition to styrenic polymers, are used in the form of recycled materials, preferably, and virgin ones. The recycled polymers used embrace not only those from postconsumption, but also the industrial residues. This invention differs from the others or by the preferential use of recycled post-consumption residues, mainly, or by the compositions, or by the distinct materials or processes applied in the production of synthetic paper sheets or films.

### FIELD OF THE INVENTION

This invention belongs to the synthetic papers field, more specifically to compositions for obtaining synthetic papers, flat and tubular films for writing and printing from composites based on recycled and virgin thermoplastic polymers, mineral loads and additives, and mono or biaxial oriented monolayer or multilayer processes and to the use of such ecologic papers and films.

### BACKGROUND OF THE INVENTION

The researches and technological developments on synthetic paper have been focused on the production of a film or sheet capable of being printed and written by a number of inks, including the aqueous inks, from virgin plastic resins. The surface proprieties of at least one of the sides of the film are adequate to be printed or written, by means of the variation of components types and concentration, kind of surface treatment, or even by means of application of different surface coatings. The mechanical and optical proprieties are also qualitatively and quantitatively described, where the film rigidity, opacity, and density are taken into account when producing synthetic paper or film for printing, with balanced proprieties.

In general, the literature, mainly of patents, reports manufacturing processes of synthetic papers and films or sheets for writing and printing, where the polyolefins are almost always a part of the compositions, in the form of multilayer films, 2 to 5 layers, coextruded or colaminated layers. The basic differences between the exposed technologies are the number, type, and concentration of polymeric components; additives and loads or inorganic reinforcements; the number of coextruded or colaminated layers; variation of orientation type, i.e., mono or bioriented layers; and surface treatments or coatings applied. For the latest, a great variety of techniques is applied, from the most conventional on polymeric films, as the case is for corona or flame discharge treatments, to the formation of micro cavitations or micro porosities by means of orientation of the films under certain temperature conditions.

The ample examination of the open literature indicates that none of the documents mentions the use of post-consumption plastic residues, even on lowermost amounts added to virgin resins. It is also possible to verify that none of the documents protects the compositions related to the specific processes or types of matrix polymer involved in this invention, even when the virgin raw material is used.

Following, the most relevant documents found are briefly described.

The paper published by S. Manrich —“Studies on Urban Plastic Residues Recycling for Substitutive Applications of Paper for Writing and Printing”, in Polymers: Science and Technology, vol. 10, No 3, p. 162-170, 2000, describes the characterization of PP residues, deriving from industrial clippings and selective urban collection, followed by mixture with CaCO₃ in a double-screw extruder. 0.3 and 1.0% TiO₂ concentrate was added to this composition of PP/CaCO₃, during the obtaining of films from these composites by process of monolayer tubular film blown extrusion. Two types of CaCO₃ were used, called PBR (20 and 40% by weight), with relatively gross granulometry, and QBP (40% by weight), with granulometry similar to the types used in this invention.

With the addition of QBP it was not possible to process the composite in the form of film. In the final conclusion of the paper, it is mentioned the fact that a number of improvements was being performed to increase the rigidity, decrease the density, in addition to increase the opacity and receptivity to other types of writing, other than graphite and ball-point writings, and of printing, other than dot matrix printer and black ink jet printer.

At developing this invention, it became clear that PP composite films without the addition of a modifying polymeric component, despite the good quality of printing, i.e., a good printability, present a poor adherence to any kind of ink, so that the compositions for the monolayer films and for the outer layers of the multilayer films are very different of those of the mentioned paper. Thus, the publishing of the results from the research performed in such paper does not represent a priority to this invention.

The Brazilian patent application PI 0003402-9 relates to a process for obtaining synthetic paper from mixtures of polyolefins with recycled polyesters, therefore, it differs from this invention, which does not include any type of polyesters in its compositions. Besides, the process of the mentioned document involves a thermo-chemical treatment step, totally differing from the process used in this invention for obtaining films or synthetic paper sheets.

The relative proportions of the materials used for manufacturing synthetic paper mainly vary with the application and type of layer, outer or inner. The core layer (or base layer) named inner layer or soul, is generally composed by 70-80% PP by weight, 20-30% CaCO₃ and 1-5% TiO₂ in average. The outer layer or surface layer for printing or writing, also known as cover, may vary a lot, both in relation to the type of material and of composition.

Patent EP 0.605.938, for example, uses for the core layer 80-95% of non-modified PP, 2-15% of CaCO₃ and 2-7% of TiO₂, with the possibility of adding up to 0.3% of an antistatic agent. For one of the outer layers, 25-50% by weight of PS or SAN, 5-15% of PP and/or modified PP, 7-20% of ethylene copolymer or terpolymer, such as EVA, 15-35% of CaCO₃ and 1 to 5% of TiO₂. The remaining outer layer can be composed similarly to the previous one or only of a PP copolymer, over which a coating composed by 10-30% of styrene copolymer and maleic anhydride, 5-20% of silica, and 1-5% of carboxymethylcellulose is applied.

In this patent, the author describes the obtainment of a coextruded and bioriented multilayer synthetic paper, with good writing and printing proprieties; however, nothing is mentioned in relation to the addition of any post-consumption plastic residue. Besides, even though the soul composition is very similar to the one of this invention, the covers compositions for the films or sheets for the co-extrusion processes are very different, as can be noted as from this report.

U.S. Pat. No. 6,083,443 refers to the BOPP process for the elaboration of synthetic paper films with one or more layers, having PP as matrix polymer; however, in addition to no mentioning the use of recycled polymers, the types of materials and the compositions are very different from those applied in any of the processes of this invention. This may be evidenced with the comparison of the compositions and materials described in the mentioned patent, listed below, with those of the report of this application.

To the PP matrix polymer, 10-40% by weight of inorganic load are added, that may be CaCO₃, dolomite, SiO₂; 20-35% of pigment/load, including in this case CaCO₃ as pigment together with TiO₂; 5-10% of wax of isotactic PP and 0.2-1.0% of wax of modified PP with maleic anhydride (PP-MAH). The CaCO₃ used has a particle mean size of 3 μm and within the range of 0.2-16 μm.

U.S. Pat. No. 5,552,011 describes a process of biorientation of PP (BOPP) for the production of synthetic paper of 3 coextruded layers. The central layer can be composed by 70-80% of PP of high crystallinity and have more than 97% of isotacticity and 10-14% of CaCO₃ concentrate, 9-13% of TiO₂ concentrate and 1-3% of antistatic agent (tertiary amine). The surface layers, in both sides of the central layer, are composed by 30-55% of PP, 30-40% of PE, 14-26% of TiO₂ concentrate, 0.5-2% of antistatic agent concentrate, 0.1-1% of ultra-violet and stabilizer and 0.4-1% of flow auxiliary.

The coextruded sheet is bioriented 3-6 times at longitudinal (MDO) and 5-12 times at transversal (TDO), obtaining a film with a thickness of 30-100 μm. Following, the bioriented film is submitted to a surface treatment by corona discharge. If the thickness required is higher than 100 μm, a coating may be applied over the film and then laminate other film layer of synthetic paper over the previous one.

In U.S. Pat. No. 6,171,443, the word “recyclable” in the title and in the text refers to a type of recyclable synthetic paper obtained with thermoplastic fibers in the form of non-woven, i.e., the product may be later recycled, however, the technology does not involve the use of recycled material. Besides, the composition and the sheet process composed by non-weaved fibers are completely different from those proposed in this invention.

Even in the most recent patents of synthetic paper and films for writing and printing, whether monolayer or multilayer and obtained by different orientation process, there are no records of use of recycled polymers, only of virgin resins. Similarly, in the conventional processes of patented bioriented films of PP (BOPP) for different applications, there is no mention concerning the addition of post-consumption plastics. The types of materials and their relative proportions, related to the process of orientation, also differ a lot from the documents, including the recent ones, according to the following comments.

Patent WO 007.196 is related to the obtainment of bioriented films in three coextruded layers for being mainly applied as labels, with the possibility of application of surface coating over one of the outer layers for printing water-based ink. The base polymer for both inner and outer layers is HDPE and derivatives. The soul should present density lower than 0.6 g/cm³ and the covers, higher than 0.9 g/cm³. However, the compositions given in such patent differ a lot from those of this application, as is shown by one of the following examples, in addition to the non-use of recycled residues. Central layer: HDPE ˜68%; CaCO₃˜16%; TiO₂ ˜4%; microcavitation agent ˜8%; antioxidant ˜0.2%; PS ˜4%; and surface layer: HDPE 75%; LLDPE 25%.

U.S. Pat. No. 6,787,217 relates to a co-extrusion process of three layers plus two binding layers between the central and surface layers for obtaining bioriented thermoplastic films. For printing with aqueous inks, it is passible of application of surface coatings and also the use of lamination processes. In relation to the composition, there is no mention of the approximate values for all the compositions components of each layer, only comments on some materials used in each layer, for example: for the central layer, isotactic PP, ethylene derivates, it mentions inclusively EVA, 0.01-2% nucleating agent; 2-4% TiO₂, 2-25% CaCO₃, cavitation agents and antioxidants. For the surface layer, homo PP or copolymer and/or HDPE, or ethylene derivates, 8-60% cavitation agent, other additives such as antistatics, anti-blockage and others, but it does not mention values in %, as well as it does not mention recycled post-consumption plastics.

It is therefore verified that the technique still requires synthetic papers, ecologic films for writing and printing, and correlated composites for flat and tubular films for writing and printing, from recycled and virgin thermoplastic polymers-, mineral loads and additives-based composites, and using monolayer or multilayer processes of mono or biaxial orientation, such related products, composites, and processes being described and claimed in this application.

### SUMMARY OF THE INVENTION

In a wide way, the invention relates to compositions for ecologic films useful for writing and printing and as synthetic ecologic paper, such compositions comprising:

Compositions of coextruded multilayer flat films for synthetic ecologic paper, such compositions comprising:

i) for the Cover

a1) a polyolefin as PP in a proportion of 50-86%, a copolymer as EVA in a proportion of 10-30%, 14-30% of CaCO₃, 1-5% of TiO₂, antistatic additive/antiblockage additive between 0-2/0-2, stabilizer between 0.1-0.3%; or alternatively

a2) a polyolefin as PP in a proportion of 33-60% and a styrenic resin as HIPS in a proportion of 12-33%, 6-15% compatibilizer agent, 10-32% of CaCO₃, 1-5% of TiO₂, antistatic additive/antiblockage additive between 0-1/0-3, stabilizer between 0.1-0.4%;

ii) for the Soul

a3) a polyolefin as PP in a proportion of 60-87%, 12-35% of CaCO₃, 0-3% of TiO₂, antistatic additive/antiblockage additive between 2-4/0-2, stabilizer between 0.1-0.4%

compositions for monolayer films of synthetic ecologic paper, such compositions comprising:

i) for Flat Films

b1) a polyolefin as HDPE in a proportion of 21-30%, a styrenic resin as HIPS (High Impact Polystyrene) in a proportion of 38-50%, 3-10% of compatibilizer agent, 15-32% of CaCO₃, 1-5% of TiO₂, antistatic additive/antiblockage additive between 0-1/0-3, stabilizer between 0.1-0.4%; or alternatively

b2) a polyolefin as PP in a proportion of 40-58%, PP being 100% virgin or mixture with recycled PP, 12-33% of a styrenic resin as HIPS, 7-15% of compatibilizer agent, 10-32% of CaCO₃, 1-5% of TiO₂, antistatic additive/antiblockage additive between 0-1/0-3, stabilizer between 0.1-0.4%;

ii) for Tubular Films:

b3) a polyolefin as HDPE in a proportion of 21-30%, a styrenic resin as HIPS (High Impact Polystyrene) in a proportion of 38-50%, 3-10% of compatibilizer agent, 15-32% of CaCO₃, 1-5% of TiO₂, antistatic additive/antiblockage additive between 0-1/0-3, stabilizer between 0.1-0.4%; or alternatively

b4) a polyolefin as PP in a proportion of 50-86%, 10-30% of EVA, 14-30% of CaCO₃, 1-5% of TiO₂, antistatic additive/antiblockage additive between 0-1/0-3, stabilizer between 0.1-0.3%.

The proportions are by weight in relation to the total of the composition.

Thus, the invention provides polyolefin-based compositions, such as PP, in mixture with styrenic resins or copolymers as EVA for flat, tubular, monolayer, or multilayer films where part of the compositions can be composed preferably of recycled resins such as industrial clippings or post-consumption PP.

The invention also provides compositions that when extruded in usual industrial machinery produce films or sheets having excellent printing proprieties for the organic solvent- and aqueous emulsions-based inks, excellent mechanic proprieties and good optical proprieties, regardless of the use of 100% recycled polymers or recycled polymers mixture with the virgin ones, even in negligible amounts of virgin materials or recycled materials.

The invention also provides compositions containing recycled polymers that produce printing proprieties comparable to those of the virgin polymer films, regardless of the process used, mono or multilayer, obtaining excellent adherence of organic solvent-based inks for recycled polymer films, of mixture of recycled ones with virgin ones or of virgin polymers.

### BRIEF DESCRIPTION OF THE DRAWINGS

FIG. 1 attached shows surface micrographies of flat films: FIG. 1A of HIPS/HDPE composite and FIG. 1B Pcel.

FIG. 2 attached shows surface micrographies of: FIG. 2A Psynt smooth face A and FIG. 2B Psynt rugose face B, with coating.

FIG. 3 attached shows surface micrographies of coextruded films, composites covers of: FIG. 3A, PP/EVA, both virgin and FIG. 3B, PP/EVA, recycled PP.

FIG. 4 attached shows the adherence test, silk-screen printing: films treated with corona discharge, with composition: FIG. 4A, rₚ5 and FIG. 4B, the same blend HIPS/HDPE, with the same additives, except CaCO₃.

### DETAILED DESCRIPTION OF THE INVENTION

This invention relates to the obtaining of synthetic paper, flat and tubular films for writing and printing, using recycled and virgin thermoplastic polymers-, mineral loads and additives-based composites and using monolayer or multilayer processes of mono or biaxial orientation.

The proposed composites are associated to the specific processes or to the specific type of matrix polymer.

Thus, an aspect of the invention is the polyolefins compositions added with another modifying polymer, mineral loads and additives.

Another aspect of the invention is the coextruded multilayer flat films, flat monolayer films and tubular films obtained from the proposed composites.

Another aspect of the invention is the use of the products obtained, such as films and synthetic paper.

Polyolefinic polymers such as polypropylene (PP), polyethylene and its derivatives, in addition to stirenic polymers, are used in the form of recycled materials, preferably, and virgin materials. The recycled polymers used embrace not only those from post-consumption residues, but also the industrial residues. This invention differs from the others or by the preferential use of recycled post-consumption residues, mainly, or by the compositions, or by the different materials or processes applied in the production of films or synthetic paper sheet.

The post-consumption residues recycling may be performed using conventional processes of cleaning and recuperation or specific processes of super-clean. Mineral loads, with and without surface treatments, in addition to additives such as antistatics, antioxidants, interface compatibilizers, antiblockages, and others, are also applied.

The composites are obtained by the mixture of the compounds in extruders or in intensive mixers with a high rotation.

The final results presented by these films or sheets are very satisfactory, with excellent printing proprieties of the organic solvent-based inks and aqueous emulsions, excellent mechanical proprieties and good optical proprieties, regardless of the use of 100% recycled polymers or recycled ones mixture with the virgin ones, even in negligible amounts of virgin or recycled materials.

The manufacturing method of these films or sheets may occur through multilayer co-extrusion with monoaxial or biaxial orientation, by means of the conventional process for producing polypropylene films known as “BOPP” or by monolayer extrusion in flat monoaxial or tubular biaxial orientation process. The single-layer films or sheets can be later co-laminated to produce synthetic paper with multiple layers.

This invention differs from the other patents published concerning synthetic paper mainly because it preferably includes post-consumption plastic residues. The addition of recycled post-consumption plastic residues is also an innovation or originality in the field of bioriented PP films BOPP, and no record or publication of this nature was found on technical-scientific or patent bases.

The use of recycled polymers produces printing proprieties comparable to the ones of the virgin polymer films, regardless of the process used, i.e., mono or multilayers. Thus, excellent adherence of organic solvent-based inks is achieved for recycled polymers film, mixture of recycled ones with virgin ones or virgin polymers.

The optical proprieties of purity are relatively damaged in the use of recycled polymers for synthetic paper in relation to the virgin ones, if certain precautions are not followed, even though they present in general good optical proprieties, thus making possible the use of these materials as synthetic paper. For example, such aspect may be significantly improved by the exclusion of residues such as of chocolate milk packages, i.e., those with dark pigments in the whole package mass. In the other hand, the presence of dark pigments may be advantageously used in ecologic marketing, producing effects in synthetic papers of a number of tonalities, making the presence of residues very visible, as it is the case of recycled conventional paper.

The compositions used for preparing the films according to the invention comprise, for multilayer films, PP/EVA or PP/HIPS such as matrix polymer for the cover and PP for the central layer, and additives.

For its turn, the compositions for flat film according to the invention comprise as matrix polymer the polyolefins, PP/HIPS and HIPS/HDPE and the tubular films comprise HIPS/HDPE or PP/EVA as matrix polymer, and additives.

The composition used for each layer of the film or synthetic paper sheet varies according to its expected specific function and to the process to be used.

Table 1 that follows shows the compositions of coextruded multilayer flat films for ecologic synthetic paper according to the invention.

Table 2 that follows shows the compositions typical for flat monolayer films and ecologic synthetic paper tubular films according to the invention, films that may also be later colaminated.

HIPS/HDPE blend-based compositions are unique and differ from the published ones, whether the recycled post-consumption plastic residues are included or not. PP blend-based films and sheets as matrix polymer (matrix phase) are unique due to the composition, or due to the types of materials or due to the orientation process, whether the recycled plastic residues are included or not. However, the use of post-consumption residues in at least one of the polymeric components is preferable.

In Tables 1 and 2, CA, AE, AB and EST respectively stand for compatibilizer agent, antistatic additive, antiblockage additive and stabilizer.

TABLE 1

| | | PP | EVA | HIPS | | CaCO₃ | TiO₂ | AE/AB | EST |
|---|---|---|---|---|---|---|---|---|---|
| | Examples | (%) | (%) | (%) | CA | (%) | (%) | (%) | (%) |
| Surf. | 1 | 50-86 | 10-30 | — | | 14-30 | 1-5 | 0-2/0-2 | 0.1-0.3 |
| (Cover) | 2 | 33-60 | | 12-33 | 6-15 | 10-32 | 1-5 | 0-1/0-3 | 0.1-0.4 |
| Central | 1 | 60-87 | — | | | 12-35 | 0-3 | 2-4/0-2 | 0.1-0.4 |
| (Soul) | | | | | | | | | |

TABLE 2

| | | PP | EVA | HIPS | HDPE | | CaCO₃ | TiO₂ | AE/AB | EST |
|---|---|---|---|---|---|---|---|---|---|---|
| | Examples | (%) | (%) | (%) | (%) | CA | (%) | (%) | (%) | (%) |
| Flat | 1 | — | — | 38-50 | 21-30 | 3-10 | 15-32 | 1-5 | 0-1/ | 0.1-0.4 |
| | | | | | | | | | 0-3 | |
| | 2 | 40-58^{(a)} | | 12-33 | | 7-15 | 10-32 | 1-5 | 0-1/ | 0.1-0.4 |
| | | | | | | | | | 0-3 | |
| Tubular | 1 | — | — | 37-48 | 21-30 | 3-12 | 15-32 | 1-5 | 0-1/ | 0.1-0.4 |
| | | | | | | | | | 0-3 | |
| | 2 | 50-86 | 10-30 | — | — | | 14-30 | 1-5 | 0-1/ | 0.1-0.3 |
| | | | | | | | | | 0-2 | |

^{(a)}100% virgin PP or mixtures of recycled PP with virgin PP, preferably virgin PPₕₑₜ

The polymers used were homopolymer PP, PP with elastomeric fraction (PPₕₑₜ) or recycled residue, fluidity index (FI) 2-15 g/10 min; Ethylene vinyl acetate (EVA) copolymer, FI 1-4.5 g/10 min; Virgin and recycled high impact polystyrene (HIPS), FI 3-10 g/10 min and virgin and recycled high density polyethylene (HDPE), FI 0.2-10 g/10 min.

The compatibilizer agents, loads and additives were used in their marketing form or in concentrates:

CA: compatibilizer agents useful for the invention purposes include diblock SB styrene-butadiene copolymers, triblocks SBS or star and linear multiblocks or “graphitized” (grafted), multiblocks SB hydrogenated copolymers such as styrene-ethylene-butylene-styrene (SEBS), graphitized copolymers of polypropylene and polyethylene with styrene (S) or maleic anhydrous (MAH) such as PP-g-S, PP-g-MAH, PE-g-S, PE-g-MAH, but not limited to them.

AE: antistatic additives useful for the invention purposes include fatty acid esters or of polyethylene glycol such as glycerol monostearate, whether mixture or not with ethoxylated amines and alkilamines, with the possibility of being mixture with sliding additives such as erucamide amides and oleamide also mixture or not with fatty acid amides such as stearamide.

AB: antiblockage additives useful for the invention purposes include porous and non-porous synthetic sylic with or without surface treatment, silicates, thin spheres of poly (methyl methacrylate) and silicone with the possibility of being mixture with sliding additives such as erucamide amides and oleamide also mixture or not with fatty acid amides such as stearamide.

EST: stabilizer additives useful for the invention purposes include phenol-, aromatic amine-, sulfate-, mercaptan-, phosphite-, benzophenone- and its derivatives-, benzotriazol-, sterically obstructed amine-, salicylic acid-, chromo- and manganese salt-, phosphorus compound-based compounds, with the possibility of being individually added or mixture.

AO: antioxidant agents useful for the invention purposes include the same compounds used as stabilizers.

Natural or precipitated CaCO₃ particulated loads, with and without surface treatment and mean size of 1-5.5 μm, and rutile TiO₂.

The post-consumption plastic residues are originated from usual or selective collection, which were subjected to conventional processes of cleaning and recuperation, obtaining the recycled resins in the final form of flakes, agglutinated or granulated, depending on the type of residue. Later, the additives were incorporated to the resins in intensive mixer of high rotation or in double-screw extruder, for then processing the composites in the form of bioriented or mono-oriented flat films or tubular films.

The processing conditions of the coextruded bioriented films were: temperatures of 155-230° C. in coextruders; temperatures in the stretching systems of 90-175° C. and with stretch ratio of 4 to 10 times in the longitudinal (MDO) and transversal (TDO) directions of the machine.

For the monolayer flat films were: screw rotation speed of 60 to 100 rpm and temperatures of 170 to 210° C., in mono-screw extruder Gerst 24 mm, L/D=24. The films were cooled with compressed air at a temperature of 25° C., at a pressure of 1.5 to 2.5 atm, while they were stretched at a speed of 10 to 16 m/min, by means of puller rolls.

The tubular films were processed in blown film extruder, Ciola FI 40, L/D=25, temperatures of 170 to 220° C., screw speed of 50 to 200 rpm, bubble-inner air pressure of 2.5 to 4.5 kgf/m², and stretch speed by puller rolls of 1.5 to 14.5 m/min.

The films or sheets obtained from different compositions were characterized in terms of surface and printing proprieties, in addition to physical and mechanical proprieties, and in some cases, a data statistical analysis with response surface was performed.

The quantitative and qualitative results were compared, whenever possible, to the ones of a cellulosic paper (Pcel) sample sulphite A4 and a marketing synthetic paper (Psynt), with two distinct surfaces or faces, one with no surface covering (face A, smoother) and other with surface covering (face B, greater rugosity).

The characterizations were pooled as follows.

Surface and Printing Proprieties

Surface morphology by Scanning Electronic Microscope (SEM). Such analysis was performed according to conventional procedure.

Surface strength, according to standard ASTM D-2578

Films surface strength γ was determined according to standard ASTM D-2578, and ethylene glycol/formamide solutions with surface strain of 36 to 54 dynes/cm were used.

Solvent- and water-based ink adherence tests according to adapted standard ASTM D-3359.

In this case, according to the standard, a X shape cut or 6 to 11 cuts in # over the printed surface with the specific ink should be performed, and make pressure to an adhesive tape over the area with the cuttings, for then violently remove the tape. The result is qualitatively evaluated in a 0-5 scale, according to the proportion of ink removed from the substrate, so that if more ink is removed, lower become its adherence to the substrate and lower become the number checked. The adaptation refers to the non-application of cuts, due to the fact that the films and sheets were very thin in average, and to the assignment of qualifications of poor, regular, good, and excellent to the adherence of the ink to the substrate.

Qualitative tests of ink adherence by off-set, silk-screen, and ink-jet processes.

The same procedure described above was adopted, however, using actual equipments, inks, and actual processes of graphic printing.

Optical Proprieties

Purity—ASTM E313

The films purity determination in terms of whiteness index (w.i) was performed according to standard ASTM E313 and using an appropriate spectrophotometer. Brightness 45°—ASTM D2457.

The films and sheets brightness was determined according to standard ASTM D2457, for the specific angle of 45°, using a brightness pattern of 56.7.

Transmittance—ASTM D-1003

The luminous transmittance propriety was determined according to procedure ASTM D1003, considering that the lower the transmittance, the greater the opacity.

Physical and Mechanical Proprieties

Grammage and Normalized grammage (grammage/thickness), according to standards NBR 5981 and DIN-53479

The grammage (Gr) propriety of a paper in g/m², gives a good idea of a sheet or film weight by area unit, however, it varies a lot with the thickness. In the other hand, the normalized grammage (GrN), i.e., the grammage/thickness ratio, gives a good idea of its density, making easier direct comparisons between films and sheets with very different thickness.

Tension, According to Standard ASTM D882

The tension assays were performed following the procedure established by standard ASTM D882 for at least 5 test samples prepared in the form of films. These were cut in the longitudinal and transversal directions, whenever possible.

Coefficient of friction (COF), according to standard ASTM D1894.

The static and kinetic coefficients of friction are calculated, respectively, through the ratio between the maximum resistance strength to the initial displacement of the strength measure device and the mean of five friction strength values, both divided by the weight of the strength measure device, according to standard ASTM D1894.

The results obtained for a number of compositions are shown in the Tables that follow.

In Table 3 the types of materials used in the compositions of the different samples are listed, and their characterization results are described. In Table 3 and in the other Tables, v, r, and vr stand for virgin resins, recycled resins, and mixture of virgin with recycled ones, respectively, and the numbers correspond to the different compositions. In case of r5, the subscripts t and p were used for differing the use of additives in the form of concentrates for the tubular films rₜ5, in contrast to the flat plans rₚ5, additives of which were in the form of powder.

TABLE 3

| | |
|---|---|
| v1, r1 | 68-80% PP/18-30% CaCO₃*/2-4% Antistatic* |
| v2, r2 | 55-65% PP/2-3% TiO₂*/15-25% EVA**/1-2% |
| | Antistatic*/12-20% CaCO₃* |
| v3, r3 | 50-60% PP/1-3% TiO₂/0.1-0.3% Stabilizer./15-27% |
| | EVA**/0.1-0.25% Antistatic/18-28% CaCO₃ |
| vr4 | 12-22% HIPS rec/48-58% PP vir/7-11% SEBS/12-22% |
| | CaCO₃*/2-3% TiO₂*/2-3% Antiblockage* |
| rₚ5 | 38-43% HIPS rec/23-30% HDPE rec/3-6% |
| | Compatibilizer/20-30% CaCO₃/0.15-0.3% Antistatic/ |
| | 0.5-2.5% TiO₂ |
| rₜ5 | 37-42% HIPS rec/23-29% HDPE rec/3-7% |
| | Compatibilizer/20-30% CaCO₃*/0.1-0.2% Antistatic*/ |
| | 0.5-2.5% TiO₂* |

*Additives in the form of concentrates.
**virgin EVA.

It is important to note that the characterization results of the samples with compositions v1 and r1 were inserted only for comparison, since v1 and are not adequate for constituting the outer surface layers for receiving the printing.

a) Surface and Printing Proprieties

Such proprieties are very important for the applicability of the films and synthetic paper developed in products for the graphic sector destined for writing and printing.

Surface Morphology

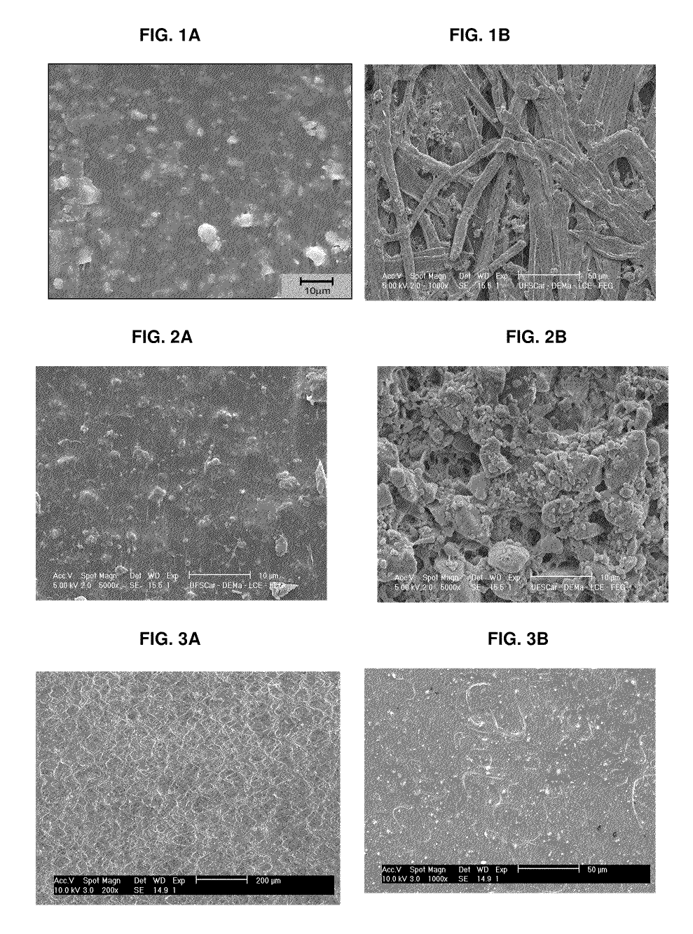

The micrography of all samples obtained by the flat mono-oriented and tubular processes was essentially the same, with homogenous dispersion and distribution of the inorganic particles, regardless of being virgin or recycled resin, of the compositions and mixture methods used. Such common morphology was also very similar to that of no-covering face (A) of sample of Psynt and totally different to that of face (B) of Psynt, with covering, and to that of Pcel, as can be verified by FIGS. 1A and 1B, and 2A and 2B.

In the other hand, the biorientation process caused differences in the surface morphology in comparison with the other processes and depending on the type of resin used (recycled or virgin). This can be verified in FIGS. 3A and 3B. The biorientation process provides a surface framing and very likely the production of a greater number of volume microcavitations, with potential influence on other proprieties.

Surface Strength (γ)

In general, γ values lower than 36 dyn/cm do not provide printability and adherence of inks of any kind or even adhesives, so its determination is important.

Table 4 that follow shows examples of surface strength and printing proprieties results for some samples.

The surface strength values were, in average, 33-38 dyn/cm for the surfaces or faces without treatment, with some exceptions for sample with no loads for blends HIPS/HDPE (31 dyn/cm) and with loads for blends PP/EVA (>42<44 dyn/cm). For the films with surface treatment, γ values were greater, in average, all above 42 dyn/cm, regardless of the matrix polymer, the type of process, and the composition, reaching values greater than 50 dyn/cm for some samples containing CaCO₃ and blends of HIPS/HDPE or PP/EVA.

According to what is seen in Table 4, listing the results of surface and printing characterizations, comparatively to the samples of cellulosic paper (Pcel) and marketing synthetic paper (Psynt), the treated films showed surface strength lower than that of Psynt, with γ=50-54 dyn/cm (face A) and γ=54-56 dyn/cm (face B) and similar and even grater to that of Pcel, with γ=45 dyn/cm.

Printing Proprieties

In contrast to what could be expected, no defined direct correlation between values greater than γ and a better printing quality of the synthetic paper samples obtained in the invention was noted. However, it was clear that the surface treatment and the presence of inorganic load particles or a polar or styrenic polymeric compound were important for an excellent printability and organic solvent- or aqueous emulsion-based ink adherence. In the other hand, when the ink was a water solvent-based ink, nor the treatment nor the components favoring the printability provided printing possibility.

Such correlation between greater values of surface strength and ink printability/adherence was also not noted when comparing the synthetic paper with Psynt and Pcel. In the case of Psynt, despite a greater γ value, the printing quality and the ink adherence were similar to that of the composite films, i.e., poor proprieties for aqueous ink and very good proprieties for the remaining tested inks.

In the case of Pcel, even with a surface strength lower than that of some synthetic paper samples, the printing proprieties were excellent, including for the water-based ink, what is explained by the presence of hydroxyl groups, highly hydrophilic, in the cellulose molecules that compose the fibers in the Pcel. In this case, it is also necessary to note that, according to what was already observed, the tests, according to the different technical standards used, can have generated values not directly comparable.

TABLE 4

| | | | | Adherence | | | |
|---|---|---|---|---|---|---|---|
| | Cover | | | | Solvent | Adherence | |
| | matrix | | | Organic | and | | Silk- |
| Process | polymer | Composition | | Solv. | Water | Off-set | screen |
| Co- | PP | v1 | >44<46 | poor | poor | good | good |
| extrusion | | r1 | >42<44 | poor | poor | good | good |
| | PP/EVA | v2 | >44<46 | excellent | poor | excellent | excellent |
| | | r2 | >40<42 | good | poor | excellent | good |
| | | r3 | >50<52 | good | poor | excellent | excellent |
| | PP/HIPS | vr4 | >48<50 | good | poor | — | — |
| Tubular | PP/EVA | v3 | >50<52 | good | poor | excellent | excellent |
| | | r3 | >50<52 | good | poor | excellent | good |
| | HIPS/HDPE | rₜ5 | >50<52 | excellent | poor | — | — |
| Flat | PP/HIPS | vr4 | >50<52 | excellent | regular | — | — |
| (mono- | HIPS/HDPE | rₚ5 | >48<50 | good | poor | excellent | excellent |
| orient.) | | | | | | | |
| Pcel | | | >44<46⁽*⁾ | excellent | excellent | excellent | excellent |
| Psynt | Face A | | >50<54 | excellent | poor | excellent | excellent |
| | Face B | | >54<56 | good | regular | excellent | excellent |

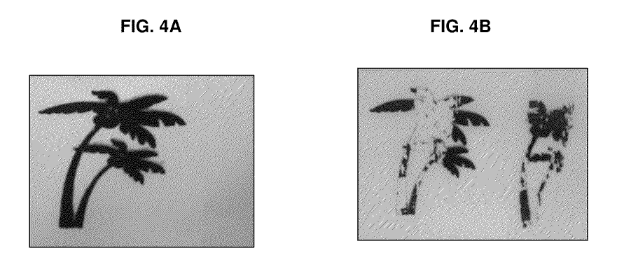

FIGS. 4A and 4B show photographies of some substrates subjected to printing tests, where the differences of printability and ink adherence are evident. The photographies also turn evident the application viability of the synthetic paper/ecologic films in product with a high aggregated value for the writing and graphic industry that use organic solvent-based ink or aqueous emulsion-based ink, regardless of the printing process.

b) Optical Proprieties

The optical characterization results are shown in Table 5, as well as the respective thickness as a reference for the transmittance, which depend thereof.

TABLE 5

| | Cover | | | | | |
|---|---|---|---|---|---|---|
| | matrix | | Purity | Brightness | Transmittance | Thickness |
| Process | polymer | Composition | (w.i.) | 45° | (%) | (μm) |
| Co- | PP | v1 | 56.6 ± 0.05 | 22.3 ± 0.3 | 12.3 ± 0.6 | 68.5 ± 4.0 |
| extrusion | | r1 | 27.2 ± 0.4 | 65.1 ± 0.4 | 13.2 ± 0.5 | 58.5 ± 2.2 |
| | PP/EVA | v2 | 53.6 ± 0.2 | 14.4 ± 0.1 | 7.3 ± 0.5 | 79.2 ± 4.2 |
| | | r2 | 11.3 ± 0.3 | 14.9 ± 0.2 | 42.8 ± 2.2 | 39.0 ± 1.0 |
| | | r3 | 28.4 ± 0.5 | 15.5 ± 0.2 | 34.6 ± 1.7 | 45.7 ± 2.1 |
| | PP/HIPS | vr4 | 21.4 ± 1.9 | 12.7 ± 0.1 | 34.0 ± 2.0 | 46.5 ± 2.2 |
| Tubular | PP/EVA | v3 | 50.5 ± 0.9 | 5.6 ± 0.2 | 73.4 ± 1.0 | 31.8 ± 1.3 |
| | | r3 | 46.3 ± 1.0 | 9.9 ± 1.7 | 71.3 ± 1.4 | 26.9 ± 1.2 |
| | HIPS/HDPE | rₜ5 | 25.7 ± 0.7 | 5.8 ± 0.4 | 44.6 ± 3.6 | 45.7 ± 1.5 |
| Flat | PP/HIPS | vr4 | 28.5 ± 0.8 | 7.3 ± 0.3 | 47.2 ± 0.8 | 103.0 ± 1.8 |
| (mono- | HIPS/HDPE | rₚ5 | 30.4 ± 1.0 | 6.2 ± 0.4 | 42.5 ± 2.1 | 55.0 ± 1.5 |
| orient.) | | | | | | |
| Pcel | — | — | 105.4 ± 1.7 | 6.6 ± 0.9 | 20.4 ± 1.0 | 89.1 ± 2.9 |
| Psynt | Face A | — | 49.3 ± 0.2 | 9.9 ± 0.0 | 14.6 ± 0.6 | 125.7 ± 4.2 |
| | Face B | — | 77.6 ± 0.4 | 6.0 ± 0.5 | — | — |

Purity

It is verified that the w.i. values, in relation to the purity, were the lowest values in the multilayer co-extrusion process for the compositions containing recycled residue and in the other processes for the compositions containing HIPS.

For the co-extruded films, this was attributed to the fact that PP residues of chocolate milk packages in the central layer (soul) were included, according to what was previously noted. In the BOPP processes, the surface layers (covers) are very thin, so that, in such samples, the soul darkest color predominated.

The w.i. values can reach the levels of Psynt face A with no covering (49.5) if the residues of chocolate milk packages are excluded from the mixture of the central layer, or adding virgin resin to recycled virgin, or even adding white pigment in the soul. For example, in the films with no HIPS, when the tubular process was used for obtaining monolayer films with the same cover composition, without the composition of the soul, the purity reached the same levels of the Psynt, as can be verified when comparing the r3 tubular (46.3) samples with r3 co-extrusion (28.5).

The purity optical propriety of the monolayer films containing recycled HIPS was also relatively poor, despite of not containing PP dark residues, probably because the HIPS became yellowed with the thermo-oxidative degradation due to successive reprocessing and the non-utilization of thermo-oxidative stabilizers. In this films, the addition of these stabilizers, or virgin resin to the recycled one, or more white pigment, or even other whitening additives, could increase the w.i. values.

However, visually, the purity level presented by the synthetic paper samples, whether monolayer or multilayer, is enough and makes possible its use products for writing and printing, with a high aggregated values. Besides, the copper color obtained in these films can be varied in different tonalities, obtaining advantages in ecologic marketing.

Brightness

In relation to the brightness measured at an angle of 45°, the values ranged between 18.5-36.4 for the flatter face of the films, and between 10.5 to 23.7 for the less flat face, in the multilayer films or sheets, with the only exception of r1, whether for the compositions containing or not post-consumption plastics, therefore, all being greater than the brightness of 9.9 and 6.0 for Psynt, faces A and B, respectively, and of 6.6 for Pcel.

The films obtained from other processes showed brightness 45° in a range nearer to that of Psynt and Pcel (5.6 to 9.9) and, in a comparison for the same compositions, the brightness of such samples is also lower in relation to that of multilayer films. This can be attributed to the physical conditions of the machinery, mainly of the puller rolls, which are maintained always highly polished in the co-extrusion equipment used.

For the writing and printing sector, the requirement of a low brightness or a great brightness depends mainly of the application to which a specific product is destined. For example, in a number of products of cellulosic paper, thin coverings of plastic resins are made for providing both a great surface brightness and an excellent protection against harmful effects from the room moistness or even directly from the water. The products with these desired proprieties can be prepared with ecologic synthetic paper, which show the various advantages, to be mentioned later, in relation to the synthetic paper of virgin resins currently in the market.

Light Transmittance

In the general application of papers and films for writing and printing, opacity is desired, i.e., a low percentage of light transmittance (Tr). However, such propriety is very variable in relation to the film thickness and, since the samples showed thickness of 26.9 up to 103.0 μm depending on the process and the composition, direct comparisons between them are not possible.

In the other hand, with the data of Table 5, it can be verified that despite of the analyzed films being much thinner than that of Psynt (125.7 μm) and Pcel (89.1 μm), transmittance is, in average, very low in the multilayer films, and in some samples, comparable and even lower to that of highly thick Pcel and Psynt. This can be explained by the production of a greater quantity of micro-cavitations and surface framings, by means of the extensive biorientation, that deviate the light rays from their trajectory.

The high Tr values for the tubular and flat films, with the only exception of flat film vr4, are explained by the lowest thickness obtained. A process conditions variation for obtaining thicker films or a co-lamination of these thin films provides a significant decrease of the light transmittance.

c) Physical and Mechanical Proprieties

Grammage (Gr) and Normalized Grammage (GrN)

The Gr and GrN results obtained are listed in Table 6 that follows, as well as the friction coefficient results.

TABLE 6

| | Cover | | | Grammage | GrN | Friction | |
|---|---|---|---|---|---|---|---|
| | Matrix | | Thickness | Gr | 10⁻⁶ | coefficient | |
| Process | Polymer | Composition | (μm) | (g/m²) | (g/m³) | Static | Dynamic |
| Co- | PP | v1 | 68.5 ± 4.0 | 38.0 ± 1.0 | 0.55 | 0.38 ± 0.01 | 0.36 ± 0.01 |
| extrusion | | r1 | 58.5 ± 2.2 | 33.5 ± 1.4 | 0.57 | 0.40 ± 0.02 | 0.36 ± 0.01 |
| | PP/EVA | v2 | 79.2 ± 4.2 | 37.6 ± 1.2 | 0.47 | 0.39 ± 0.02 | 0.34 ± 0.01 |
| | | r2 | 39.0 ± 1.0 | 35.1 ± 0.8 | 0.90 | 0.35 ± 0.01 | 0.30 ± 0.01 |
| | | r3 | 45.7 ± 2.1 | 36.1 ± 1.1 | 0.79 | 0.40 ± 0.01 | 0.31 ± 0.01 |
| | PP/HIPS | vr4 | 46.5 ± 2.2 | 38.8 ± 0.9 | 0.83 | 0.37 ± 0.02 | 0.31 ± 0.01 |
| Tubular | PP/EVA | v3 | 31.8 ± 1.3 | 29.6 ± 0.2 | 0.93 | 0.61 ± 0.03 | 0.49 ± 0.02 |
| | | r3 | 26.9 ± 1.2 | 26.9 ± 0.6 | 1.00 | 0.52 ± 0.04 | 0.45 ± 0.03 |
| | HIPS/HDPE | rₜ5 | 45.7 ± 1.5 | 50.5 ± 0.9 | 1.10 | 0.49 ± 0.04 | 0.37 ± 0.0 |
| Flat | PP/HIPS | vr4 | 103.0 ± 1.8 | 98.3 ± 1.1 | 0.95 | 0.55 ± 0.01 | 0.45 ± 0.01 |
| (mono- | HIPS/HDPE | rₚ5 | 55.0 ± 1.5 | 71.7 ± 1.0 | 1.30 | 0.43 ± 0.01 | 0.36 ± 0.01 |
| orient.) | | | | | | | |
| Pcel | | | 89.1 ± 2.9 | 75.3 ± 1.3 | 0.85 | 0.30 ± 0.01 | 0.33 ± 0.01 |
| Psynt | Face A | | 125.7 ± 4.2 | 93.1 ± 1.9 | 0.74 | 0.36 ± 0.01 | 0.43 ± 0.02 |

Among the samples compared in this report, it is verified that the grammage of all the synthetic paper films were lower than that of the Psynt and Pcel, mainly due to their thickness, that were also lower, with the only exception of the mono-oriented flat film vr4, which thickness was much greater than the average of the samples, being similar to that of the Psynt. In relation to the GrN, all the values were within the density ranges of 0.4 to 1.4 g/cm³ presented in patents published on synthetic paper. Besides, most of the samples showed similar or lower values than that of the Psynt and Pcel, what makes the use of these ecologic products even more attractive.

As can be verified by Table 6, in a general way, comparatively to the flat and tubular monolayer processes used, the multilayer BOPP process favored the obtaining of less “dense” films, attributed to the fact that the extensive biorientation promoted the production of a greater quantity of micro-cavitations.

It is also important to note the great difference between the normalized grammage of the samples v1 (0.47 g/cm³) and r1 (0.90 g/cm³), of same composition and obtained by the same multilayer co-extrusion process, only replacing the virgin resin by the recycled one. Since the process conditions were not the same, the relative proportion of microvoid spaces produced was very likely greater in the conditions used in the first case.

It is important to emphasize that the GrN that is greater than that of cellulosic and marketing synthetic papers analyzed presented by some of the films developed, does not hinder its use in industrial products. In these cases, the applications in relatively thin films can be directed. For example, considering a film of same area, despite of its high GrN, the sample r5 will be lighter than Psynt and Pcel, their replacement being possible with no damages to their printing proprieties with solvent- and aqueous emulsion-based inks.

Friction Coefficient

Such propriety is important in the sense of comparatively evaluate the easiness of running a sheet or a film in a continuous printing equipment, for example, or separate them from a stack, in an intermittent printing.

The multilayer synthetic paper films developed herein showed excellent results of friction coefficient. It is noted that, in both static (COFs) and dynamic (COFd) characterizations the values were all between those of Pcel and Psynt, i.e., 0.33≦COFs≦0.43 and 0.30≦COFd≦0.36 with the only exception of the tubular films v3 and r3 and mono-oriented flat films vr4, which values were relatively high. For such cases, in the same way of the effect over the brightness, the equipment highly polished surfaces (puller rolls) provide flatter surfaces that, in their turn, show lower friction coefficients.

Therefore, it is possible that in the mono-oriented and tubular flat film extrusion processes, if it is required, the adequacy of the machine conditions to decrease COFs and COFd. It is also possible to decrease the concentration of load particles or add a minimal amount of sliding agent, with no damages to the printing proprieties.

Tension Proprieties

In Table 7 it is found the tension assay results (elasticity module, maximum resistance, and rupture deformation). Despite of the characterization of the elasticity module (E), the rupture deformation (εᵣ) and the maximum resistance (σₘₐₓ), the E value was determinant for a comparative assessment of the samples rigidity.

All the samples showed modules very similar to those of Psynt, whether in the longitudinal direction of the machine (MDO) or in the transversal direction (TDO). In comparison to Pcel, with high E values due to mechanical reinforcement provided by the cellulose rigid fibers, all the developed films showed relatively low elasticity modules. However, in a manual qualitative evaluation, the rigidity differences in relation to Pcel are minimal. In case of the HIPS/HDPE films and sheets, due to the little rupture deformation, applications with a printing that covers all the film area or a posterior co-lamination, mainly in conjunction with a supporting or central layer, and with HDPE as the matrix polymer, are preferred.

TABLE 7

| | | | Longitudinal | | | Transversal | | |
|---|---|---|---|---|---|---|---|---|
| | Cover | | | Rup. | Max. | | Rup. | Max. |
| | matrix | | Module | Def. | F. | Module | Def. | F. |
| Process | polymer | Composition | (Gpa) | (%) | (Mpa) | (Gpa) | (%) | (Mpa) |
| Coextrusion | PP | v1 | 1.24 ± 0.02 | 136 ± 16 | 59.8 ± 5.4 | 0.77 ± 0.04 | 19.1 ± 3.6 | 48.2 ± 3.0 |
| | | r1 | 1.26 ± 0.02 | 121.4 ± 40.4 | 84.4 ± 14.3 | 0.56 ± 0.04 | 19.6 ± 9.3 | 51.3 ± 10.2 |
| | PP/EVA | v2 | 1.11 ± 0.04 | 89.3 ± 7.6 | 44.2 ± 7.8 | 0.58 ± 0.04 | 10.9 ± 4.8 | 30.9 ± 1.0 |
| | | r2 | 1.41 ± 0.03 | 38.9 ± 9.1 | 82.0 ± 5.0 | 0.81 ± 0.05 | 67.6 ± 42.7 | 34.8 ± 5.5 |
| | | r3 | 1.06 ± 0.17 | 40.7 ± 8.7 | 79.0 ± 5.9 | 0.66 ± 0.12 | 108 ± 58 | 33.1 ± 3.8 |
| Tubular | HIPS/HDPE | rₜ5 | 1.33 ± 0.11 | 50.7 ± 11.3 | 28.6 ± 2.0 | 1.22 ± 0.12 | 1.22 ± 0.12 | 12.7 ± 2.2 |
| Flat | PP/HIPS | vr4 | 1.12 ± 0.91 | 71.8 ± 4.8 | 26.2 ± 1.30 | — | — | — |
| (mono | HIPS/HDPE | rₚ5 | 1.43 ± 0.20 | 23.6 ± 6.6 | 29.8 ± 2.0 | 1.24 ± 0.10 | 1.54 ± 0.81 | 11.5 ± 2.0 |
| orient) | | | | | | | | |
| Pcel | | | 3.94 ± 0.25 | 4.2 ± 0.7 | 60.5 ± 2.8 | 1.68 ± 0.06 | 8.29 ± 1.27 | 30.3 ± 1.8 |
| Psynt | | | 1.28 ± 0.05 | 74.3 ± 1.4 | 103 ± 4.0 | 0.70 ± 0.05 | 34.4 ± 12.1 | 28.9 ± 8.3 |

In a general way, regardless of the use of recycled post-consumption plastic residues, the results of the physical and mechanical proprieties presented by the sample indicate an excellent rigidity and “density”, as well as adequate friction coefficients for the practical use of such product as synthetic paper and films for writing and printing. The optical proprieties were satisfactory, with the possibility of reaching the purity levels of virgin resin marketing synthetic papers, since some precautions are followed, or also varying the color tonalities for ecologic marketing. In its turn, the printing results were excellent for the organic solvent- and aqueous emulsion-based inks, regardless of the recycled post-consumption plastic residues compose 100% of the resins in the compositions, or in mixtures with virgin resins, even in negligible amounts, concluding the viability of the application desired for the final product.

1. Compositions for synthetic paper and ecologic films for writing and printing wherein such compositions are constituted by mixtures or composites of recycled and virgin thermoplastic polymers, mineral loads, and additives, such compositions comprising: for coextruded multilayer flat films, for the cover, in relation to the composition total weight, a polyolefin including PP in a proportion of 50-86%, an ethylene copolymer including EVA in a proportion of 10-30%, 14-30% of CaCO₃, 1-5% of TiO₂, anti-static additive/anti-blockage additive between 0-2/0-2, stabilizer between 0.1-0.3%; for coextruded multilayer flat films with monoaxial or biaxial orientation, for the cover, in relation to the composition total weight, a polyolefin including PP in a proportion of 33-60% and a styrenic resin including HIPS in a proportion of 12-33%, compatibilizer agent 6-15%, 10-32% of CaCO₃, 1-5% of TiO₂, anti-static additive/anti-blockage additive between 0-1/0-3, stabilizers between 0.1-0.4%; for tubular films with biaxial orientation, in relation to the composition total weight, a polyolefin including PP in a proportion of 50-86%, 10-30% of EVA, 14-30% of CaCO₃, 1-5% of TiO₂, anti-static agent/anti-blockage agent between 0-1/0-3, stabilizer between 0.1-0.3%; for flat films with monoaxial orientation, a proportion by weight in relation to the composition total weight, of a polyolefin including HDPE in a proportion of 21-30%, a styrenic resin including HIPS (High Impact Poly Styrene) in a proportion of 38-50%, 3-10% of compatibilizer agent, 15-32% of CaCO₃, 1-5% of TiO₂, anti-static additive/anti-blockage additive between 0-1/0-3, stabilizer between 0.1-0.4%.

2. Compositions, according to claim 1, for coextruded multilayer flat films, wherein the cover is preferably constituted by, in relation to the composition total weight, 50-60% of recycled PP, 1-3% of TiO₂, 0.1-0.3% of stabilizer, 15-27% of virgin EVA, 0.1-0.25% of anti-static agent and 18-28% of CaCO₃.

3. Compositions, according to claim 1, for coextruded multilayer flat films, wherein the cover is alternatively constituted by, in relation to the composition total weight, 55-65% of recycled PP, 2-3% of TiO₂, 15-25% of virgin EVA, 1-2% of anti-static agent, 12-20% of CaCO₃.

4. Compositions, according to claim 1, for coextruded multilayer plan films, wherein the cover is alternatively constituted, in relation to the composition total weight, by 55-65% of virgin PP, 2-3% of TiO₂, 15-25% of virgin EVA, 1-2% of anti-static agent, 12-20% of CaCO₃.

5. Compositions, according to claim 1, wherein such compositions comprise, in relation to the composition total weight, for the soul, a polyolefin including PP in a proportion of 60-87%, 12-35% of CaCO₃, 0-3% of TiO₂, anti-static additive/anti-blockage additive between 2-4/0-2, and stabilizer between 0.1-0.4%.

6. Compositions, according to claim 1, for coextruded multilayer flat films, wherein they are preferably constituted by 12-22% recycled HIPS, 48-58% of virgin PP, 7-11% of SEBS, 12-22% of CaCO₃, 2-3% of TiO₂ and 2-3% of anti-blockage agent.

7. Compositions, according to claim 1, for coextruded multilayer flat films, wherein such compositions comprise, in relation to the composition total weight, for the soul, a polyolefin including PP in a proportion of 60-87%, 12-35% of CaCO₃, 0-3% of TiO₂, anti-static additive/anti-blockage additive between 2-4/0-2, and stabilizer between 0.1-0.4%.

8. Compositions, according to claim 1, for tubular films with biaxial orientation, wherein such compositions are preferably constituted by 50-60% of recycled PP, 1-3% of TiO₂, 0.1-0.3% stabilizer agent, 15-27% of virgin EVA, 0.1-0.25% of anti-static agent and 18-28% of CaCO₃

9. Compositions, according to claim 8, wherein such compositions are alternatively constituted by 50-60% of virgin PP, 1-3% of TiO₂, 0.1-0.3% of stabilizer agent, 15-27% of virgin EVA, 0.1-0.25% of anti-static agent and 18-28% of CaCO₃

10. Compositions, according to claim 1, for tubular films with biaxial orientation, wherein such compositions are alternatively constituted by HDPE in a proportion of 21-30%, a styrenic resin including HIPS (High Impact Poly Styrene) in a proportion of 37-48%, 3-12% of compatibilizer agent, 15-32% of CaCO₃, 1-5% of TiO₂, anti-static additive/anti-blockage additive between 0-1/0-3, stabilizer between 0.1-0.4%.

11. Compositions, according to claim 10, wherein they are preferably constituted by a proportion by weight in relation to the composition total weight, of 37-42% of recycled HIPS, 23-29% of recycled HDPE, 3-7% of compatibilizer agent, 20-30% of CaCO₃, 0.1-0.2% of anti-static agent and 0.5-2.5% of TiO₂

12. Compositions, according to claim 1, for monoaxial orientation flat films, wherein they are preferably constituted by a proportion by weight in relation to the composition total weight, of 38-43% of recycled HIPS, 23-30% of recycled HDPE, 3-6% of compatibilizer agent, 20-30% of CaCO₃, 0.15-0.3% of anti-static agent and 0.5-2.5% of TiO₂.

13. Compositions, according to claim 1, for monoaxial orientation flat films, wherein such compositions alternatively comprise, for monoaxial orientation flat films, a proportion by weight in relation to the composition total weight, of a polyolefin including PP in a proportion of 40-58%, PP being 100% virgin or virgin PP mixture with recycled PP, 12-33% of a styrenic resin including recycled HIPS, 7-15% of compatibilizer agent, 10-32% of CaCO₃, 1-5% of TiO₂, anti-static additive/anti-blockage additive between 0-1/0-3, stabilizer between 0.1-0.4%.

14. Compositions, according to claim 13, wherein such compositions preferably comprise, for monoaxial orientation flat films, a proportion by weight in relation to the composition total weight, of 12-22% recycled HIPS, 48-58% of virgin PP, 7-11% of SEBS, 12-22% of CaCO₃, 2-3% of TiO₂ and 2-3% of anti-blockage agent.

15. Synthetic papers and coextruded multilayer flat films from the compositions according to claim 2, wherein they present surface strength Y between 50 and 52 dynes/cm with a good adherence in the presence of organic solvent, excellent adherence for off-set printing and silk-screen printings, purity of 28.4±0.5 w.i, brightness at 45° 15.5±0.2, transmittance 34.6±1.7, thickness 45.7±2.1 μm, grammature 36.1±1.1 g/m², GrN.10⁻⁶ 0.79 g/m², static friction coefficient 0.40±0.01, and dynamic friction coefficient 0.31±0.01, and mechanical proprieties: in the longitudinal direction, module in Gpa, 1.06±0.17, rupture deformation, 40.7±8.7%, and maximum tension 79.0±5.9 Mpa and in the transversal direction, module in Gpa, 0.66±0.12, rupture deformation, 108±58%, and maximum tension 33.1±3.8 Mpa.

16. Synthetic paper and coextruded multilayer flat films from the compositions according to claim 3, wherein the present surface strength Y between 40 and 42 dynes/cm with a good adherence in the presence of organic solvent, excellent adherence for off-set printing and good adherence for silk-screen printing, purity of 11.3±0.3 w.i, brightness at 45° 14.9±0.2, transmittance 42.8±2.2, thickness 39.0±1.0 μm, grammature 35.1±0.8 g/m², GrN.10⁻⁶ 0.90 g/m², static friction coefficient 0.35±0.01 and dynamic friction coefficient 0.30±0.01, and mechanical proprieties: in the longitudinal direction, module in Gpa, 1.41±0.03, rupture deformation, 38.9±9.1%, and maximum tension 82.0±5.0 Mpa and in the transversal direction, module in Gpa, 0.81±0.05, rupture deformation, 67.6±42.7%, and maximum tension 34.8±5.5 Mpa.

17. Synthetic papers and coextruded multilayer flat films from the compositions according to claim 4, wherein they present surface strength Y between 44 and 46 dynes/cm with a good adherence in the presence of organic solvent, excellent adherence for off-set and silk-screen printings, purity for 53.6±0.2 w.i, brightness at 45° 14.4±0.1, transmittance 7.3+0.5, thickness 79.2±4.2 μm, grammature 37.6±1.2 g/m², GrN.10⁻⁶ 0.47 g/m², static friction coefficient 0.39±0.02 and dynamic friction coefficient 0.34±0.01, and mechanical proprieties: in the longitudinal direction, module in Gpa, 1.11±0.04, rupture deformation, 89.3±7.6%, and maximum tension 44.2±7.8 Mpa and in the transversal direction, module in Gpa, 0.58±0.04, rupture deformation, 10.9±4.8%, and maximum tension 30.9±1.0 Mpa.

18. Synthetic papers and flat films obtained by co-extrusion from the compositions according to claim 6, wherein they present surface strength Y between 48 and 50 dynes/cm with a good adherence in the presence of organic solvent, purity of 21.4±1.9 w.i, brightness at 45° 12.7±0.1, transmittance 34.0±2.0, thickness 46.5±2.2 μm, grammature 38.8±0.9 g/m², GrN.10⁻⁶ 0.83 g/m², static friction coefficient 0.37±0.02 and dynamic friction coefficient 0.31±0.01.

19. Synthetic papers and coextruded multilayer flat films, wherein the soul of such papers comprises the compositions according to claim 5.

20. Synthetic papers and bioriented tubular films obtained by extrusion from the compositions according to claim 8, wherein they present surface strength Y between 50 and 52 dynes/cm with a good adherence in the presence of organic solvent, excellent adherence for off-set printing and good adherence for silk-screen printing, purity of 46.3±1.0 w.i, brightness at 45° 9.9±1.7, transmittance 71.3±1.4, thickness 26.9±1.2 μm, grammature 26.9±0.6 g/m², GrN.10⁻⁶ 1.0 g/m², static friction coefficient 0.52±0.04 and dynamic friction coefficient 0.45±0.03.

21. Synthetic papers and bioriented tubular films obtained by extrusion from the compositions according to claim 9, wherein they present surface strength Y between 50 and 52 dynes/cm with a good adherence in the presence of organic solvent, excellent adherence for off-set printing and excellent for silk-screen printing, purity of 50.5±0.9 w.i, brightness at 45° 5.6±0.2, transmittance 73.4±1.0, thickness 31.8±1.3 μm, grammature 29.6±0.2 g/m², GrN.10⁻⁶ 0.93 g/m², static friction coefficient 0.61±0.03 and dynamic friction coefficient 0.49±0.02.

22. Synthetic papers and bioriented tubular films obtained by extrusion from the compositions according to claim 11, wherein they present surface strength y between 50 and 52 dynes/cm with an excellent adherence in the presence of organic solvent, purity of 25.7±0.7 w.i, brightness at 45° 5.8±0.4, transmittance 44.6±3.6, thickness 45.7±1.5 μm, grammature 50.5±0.9 g/m², GrN.10⁻⁶ 1.10 g/m², static friction coefficient 0.49±0.04 and dynamic friction coefficient 0.37±0.0 and mechanical proprieties: in the longitudinal direction, module in Gpa, 1.33±0.11, rupture deformation, 50.7±11.3%, and maximum tension 28.6±2.0 Mpa and in the transversal direction, module in Gpa, 1.22±0.12, rupture deformation, 1.22±0.12%, and maximum tension 12.7±2.2 Mpa.

23. Synthetic papers and mono-oriented flat films obtained by extrusion from the compositions according to claim 12, wherein they present surface strength Y between 48 and 50 dynes/cm with a good adherence in the presence of organic solvent and excellent adherence for the off-set and silk-screen printings, purity of 30.4±1.0 w.i, brightness at 45° 6.2±0.4, transmittance 42.5±2.1, thickness 55.0±1.5 μm, grammature 71.7±1.0 g/m², GrN.10⁻⁶ 1.30 g/m², static friction coefficient 0.43±0.01 and dynamic friction coefficient 0.36±0.01 and mechanical proprieties: in the longitudinal direction, module in Gpa, 1.43±0.20, rupture deformation, 23.6±6.6%, and maximum tension 29.8±2.0 Mpa, and in the transversal direction, module in Gpa 1.24±0.10, rupture deformation 1.54±0.81%, and maximum tension 11.5±2.0 Mpa.

24. Synthetic papers and mono-oriented flat films obtained by extrusion from the compositions according to claim 14, wherein they present surface strength y between 50 and 52 dynes/cm with an excellent adherence in the presence of organic solvent, purity of 28.5±0.8 w.i, brightness at 45° 7.3±0.3, transmittance 47.2±0.8, thickness 103.0±1.8 μm, grammature 98.3±1.1 g/m², GrN.10⁻⁶ 0.95 g/m², static friction coefficient 0.55±0.01 and dynamic friction coefficient 0.45±0.01 and mechanical proprieties in the longitudinal direction, module in Gpa, 1.12±0.91, rupture deformation, 71.8±4.8%, and maximum tension 26.2±1.30 Mpa.

25. Use of the synthetic papers and films obtained according to claim 15, wherein such synthetic papers and films are applied in replacement to the cellulosic-origin papers for printing.
